(19) United States
(12) Patent Application Publication
(10) Pub. No.: US 2026/0290950 A1
(43) Pub. Date: Sep. 24, 2026

(54) SECONDARY BATTERY

(71) Applicant: SAMSUNG SDI CO., LTD., Yongin-si (KR)

(72) Inventors: SEOHYUN PARK, Yongin-si (KR); YOOJUNG LEE, Yongin-si (KR)

(21) Appl. No.: 19/288,107

(22) Filed: Aug. 1, 2025

(30) Foreign Application Priority Data
Mar. 19, 2025 (KR) 10-2025-0035245

(51) Int. Cl. H01M 50/105; H01M 10/04; H01M 10/052

(52) U.S. Cl. CPC H01M 50/105; H01M 10/049; H01M 10/052

(57) ABSTRACT

A secondary battery includes an electrode assembly and a pouch including a body in which the electrode assembly is accommodated. The pouch also includes a wing portion extending from a side surface of the body. The wing portion includes an extension portion extending in a thickness direction of the electrode assembly and a folded portion folded about an axis that extends in a longitudinal direction of the electrode assembly. The wing portion connects the extension portion to the body, and a hardness of an area of the wing portion is greater than a hardness of an area of the body.

### CROSS-REFERENCE TO RELATED APPLICATION

This application is based on and claims priority under 35 U.S.C. §119 to Korean Patent Application No. 10-2025-0035245, filed on Mar. 19, 2025, in the Korean Intellectual Property Office, the disclosure of which is incorporated by reference herein in its entirety.

### BACKGROUND

### Field

Embodiments relate to a secondary battery, and more particularly, to a secondary battery having improved structural stability.

### Description of the Related Art

A secondary battery includes a positive electrode, a negative electrode, and a separator interposed between the positive electrode and the negative electrode, with the electrodes and separator being wound or stacked to form an electrode assembly. The electrode assembly is sealed in a pouch or the like together with an electrolyte.

In a process of designing pouch-type secondary batteries, methods of sealing a wing portion of a pouch attempt to improve the stability and reliability of secondary batteries.

The information disclosed in this section is only for enhancement of understanding of the background of the present disclosure and may contain information that does not form related or prior art.

### SUMMARY

A pouch-type secondary battery of the present disclosure may further include a pouch having a folded wing portion without any other additives so that stability may be further improved.

However, the technical objects to be solved by the present disclosure are not limited to the above, and other objects that are not described herein will be clearly understood by those skilled in the art from the following portion descriptions of the present disclosure.

A secondary battery according to an aspect of the present disclosure includes an electrode assembly, and a pouch including a body in which the electrode assembly is accommodated, with the pouch including a wing portion extending from a side of the body, wherein the wing portion includes an extension portion extending in a thickness direction of the electrode assembly and a folded portion folded about an axis that extends in a longitudinal direction of the electrode assembly, with the folded portion connecting the first extension portion to the body, and a hardness of an area of the wing portion is greater than hardness of an area of the body.

In an embodiment, an elongation of the area of the wing portion may be less than an elongation of the area of the body.

In an embodiment, a grain size of the area of the wing portion may be greater than a grain size of the area of the body.

In an embodiment, a length of the first folded portion may be 200% or more of a thickness of a wall of the body of the pouch.

In an embodiment, the secondary battery may further include a second folded portion folded about the axis toward the body and extending from a side portion of the first extension portion that is not connected to the first folded portion.

In an embodiment, a hardness of the second folded portion may be greater than a hardness of the first extension portion.

In an embodiment, an elongation of the second folded portion may be less than an elongation of the first extension portion.

In an embodiment, a grain size of the second folded portion may be greater than a grain size of the first extension portion.

In an embodiment, a grain size of the second folded portion may be 100 μm or more.

In an embodiment, the secondary battery may further include a second extension portion extending from a side of the second folded portion that is connected to the first extension portion, and the second extension portion may be located between the first extension portion and the body.

In an embodiment, the second folded portion may be spaced from the body.

A method of manufacturing a secondary battery according to an aspect of the present disclosure includes forming an electrode assembly, accommodating the electrode assembly in a body of a pouch, with the pouch including a wing portion extending from the body, sealing the wing portion of the pouch, forming a folded portion by folded the wing portion about an axis that extends in a longitudinal direction of the electrode assembly, and irradiating light onto the folded portion to increase strength of the folded portion, , and a hardness of an area of the wing portion is greater than hardness of an area of the body.

In an embodiment, an elongation of the area of the wing portion may be less than an elongation of the one area of the body.

In an embodiment, a grain size of the area of the wing portion may be greater than a grain size of the area of the body.

In an embodiment, the increasing of the strength of the folded portion may include photo-sintering the folded portion.

In an embodiment, a length of the folded portion may be 200% or more of a thickness of a wall of the pouch.

In an embodiment, the forming of the folded portion may include forming a second folding by performing a first folding about the axis, and forming a first folded portion by performing second folding toward the electrode assembly, and a first extension portion may be disposed between the first folded portion and the second folded portion.

In an embodiment, the forming of the second folded portion may include irradiating light onto a first folded area after the first folding, and the forming of the first folded portion may include irradiating light onto a second folded area after the second folding.

In an embodiment, a hardness of the second folded portion may be greater than a hardness of the first extension portion.

In an embodiment, the secondary battery may further include a second extension portion extending from a side opposite to a side of the second folded portion that is connected to the first extension portion, and the second extension portion may be located between the first extension portion and the body.

### BRIEF DESCRIPTION OF THE DRAWINGS

The accompanying drawing illustrate exemplary embodiments of the present disclosure and, together with the following portion detailed description, serve to provide further understanding of the technical spirit of the present disclosure. However, the present disclosure is not limited to the details shown in the drawing portions.

FIG. 1 is a perspective view of a secondary battery according to an embodiment of the present disclosure;

FIG. 2 is a perspective view of an electrode assembly of FIG. 1;

FIG. 3 is a plan view of the secondary battery according to an embodiment of the present disclosure;

FIG. 4 is a cross-sectional view of a cross section taken along line I-I’ of FIG. 3; and

FIGS. 5 to 9 are cross-sectional views of a process of manufacturing a secondary battery according to an embodiment of the present disclosure.

### DETAILED DESCRIPTION

Hereinafter, embodiments of the present disclosure will be described with reference to the accompanying drawings. It should be understood that the terms used in the specification and the appended claims should not be construed as limited to general and dictionary meanings, but interpreted based on the meanings and concepts corresponding to technical aspects of the present disclosure based on the principle that the inventor is allowed to define terms appropriately for the best description. Accordingly, embodiments disclosed in the present specification and configurations illustrated in the drawing portions are merely exemplary embodiments of the present disclosure and do not represent all of the technical ideas of the present disclosure. Thus, it should be understood that there may be various equivalents and modifications that can substitute these at the time of filing of the present application.

Further, “comprise and include” and/or “comprising and including” used in this specification should be interpreted as specifying the presence of described shapes, numbers, steps, operations, members, elements, and/or groups thereof and do not exclude the presence or addition of other shapes, numbers, operations, members, elements, and/or groups thereof. The use of “may” and “may be” when describing embodiments of the present disclosure refers to “one or more embodiments of the present disclosure.”

In some embodiments, for a better understanding of the present disclosure, the drawings are not illustrated in actual scale and sizes of some elements may be exaggerated. In some embodiments, the same reference numbers may be assigned to the same components in different embodiments.

Stating that two objects of comparison are “the same” means that the two objects of comparison are “substantially the same.” Therefore, substantially the same may include a deviation that is considered low in the art, for example, a deviation of 5% or less. In addition, uniformity of a parameter in a certain area may mean uniformity from an average perspective.

It will be understood that, although the terms first, second, and the like are used herein to describe various components, these components should not be limited by these terms. These terms are only used to distinguish one component from another component, and a first component may also be a second component unless particularly described otherwise.

Throughout the specification, each component may be singular or plural unless particularly described otherwise.

When it is said that an element is disposed on “an upper portion (or a lower portion)” of an element or disposed “above (or below)” an element, this may not only mean that the element is disposed in contact with an upper surface (or a lower surface) of the element, but also mean that another element may be interposed between the element and the element disposed above (or below) the element.

Also, when it is said that a certain element is “connected” or “coupled” to another element, this may mean that the elements are directly connected or coupled to each other, but it should be understood that another element may be “interposed” between the elements or the elements may be “connected” or “coupled” to each other via another element. Further, the term “electrically coupled” may mean not only “directly coupled” but also may include “coupled via other interposing component.”

Throughout the specification, “A and/or B” refers to “A, B, or A and B” unless particularly described otherwise. That is, “and/or” includes all or any combination of a plurality of listed items. “C to D” refers to C or more and D or less unless particularly described otherwise.

The terms used in this specification are for describing embodiments of the present disclosure and are not intended to limit the present disclosure.

Hereinafter, embodiments of the present disclosure will be described in detail with reference to the accompanying drawings, wherein like reference numerals refer to the same or corresponding components throughout the drawing portions.

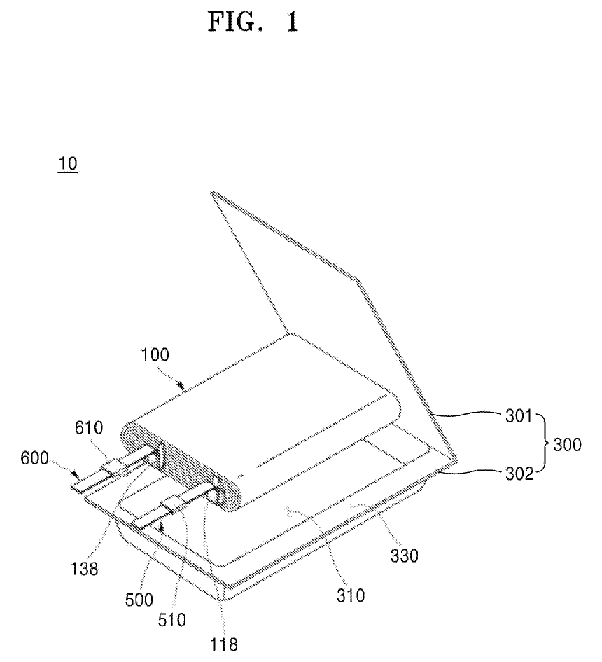

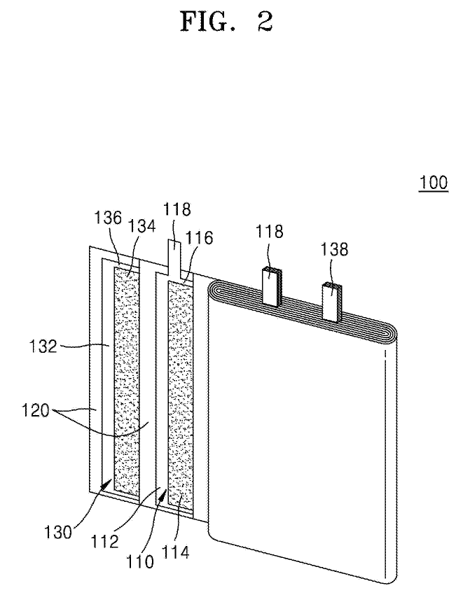

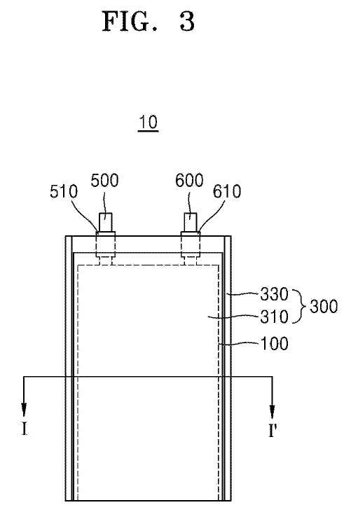

FIG. 1 is a perspective view of a secondary battery 10 according to an embodiment of the present disclosure. FIG. 2 is a perspective view of an electrode assembly 100 of FIG. 1. FIG. 3 is a plan view of the secondary battery 10 according to an embodiment of the present disclosure.

Referring to FIGS. 1 to 3, the secondary battery 10 of the present disclosure may include the electrode assembly 100 and a pouch 300 that accommodates the electrode assembly 100.

The electrode assembly 100 may be formed by winding or stacking a negative electrode plate 110, a separator 120, and a positive electrode plate 130 which are formed in a thin film or film shape. Herein, the electrode assembly 100 is described as a wound type formed by winding. The negative electrode plate 110 and the positive electrode plate 130 may be electrically connected to an external device of the secondary battery 10 through a first strip terminal 500 and a second strip terminal 600, respectively. The depicted electrode assembly 100 is commonly referred to as a jelly roll.

The negative electrode plate 110 may be formed by applying a negative electrode active material 114 such as graphite or carbon onto a negative electrode current collector 112 including metal foil made of copper, a copper alloy, nickel, or a nickel alloy. A negative electrode uncoated portion 116 where the negative electrode active material 114 is not applied may be formed in a partial area of the negative electrode current collector 112. A plurality of negative electrode substrate tabs 118 may be formed on the negative electrode uncoated portion 116 in a width direction of the negative electrode current collector 112. The negative electrode substrate tab 118 may be formed, for example, by pressing the negative electrode uncoated portion 116 to a certain shape. As an example, the negative electrode substrate tab 118 may have a quadrangular shape. The plurality of negative electrode substrate tabs 118 extend outward from the negative electrode current collector 112. In FIG. 2, the plurality of negative electrode substrate tabs 118 extend upward.

As the electrode assembly 100 is wound, the plurality of negative electrode substrate tabs 118 are stacked. Herein, the meaning of "stacking" of substrate tabs includes not only a configuration in which the substrate tabs are stacked in complete contact with each other, but may mean that the substrate tabs are stacked at a certain distance and stacked at a different level at the same position. The negative electrode substrate tab 118 forms a path for a current flow between the negative electrode plate 110 and the first strip terminal 500. The plurality of stacked negative electrode substrate tabs 118 may be spaced apart from each other to not overlap a plurality of stacked positive electrode substrate tabs 138 of the positive electrode plate 130 (to be described below). For example, in FIG. 2, all of substrate tabs disposed at a left side of the electrode assembly 100 may be the negative electrode substrate tabs 118, and all of substrate tabs disposed at a right side of the electrode assembly 100 may be the positive electrode substrate tabs 138.

The separator 120 is interposed between the negative electrode plate 110 and the positive electrode plate 130 to prevent a short circuit between the negative electrode plate 110 and the positive electrode plate 130 and enable the movement of lithium ions. For these functions, the separator 120 may be larger than the negative electrode plate 110 and the positive electrode plate 130. The separator 120 may be made of polyethylene, polypropylene, or a composite film of polyethylene and polypropylene, but the present disclosure is not limited to these examples.

The positive electrode plate 130 may be formed by applying a positive electrode active material 134 such as a transition metal oxide onto a positive electrode current collector 132 including foil made of aluminum or an aluminum alloy. A positive electrode uncoated portion 136 where the positive electrode active material 134 is not applied may be formed in a partial area of the positive electrode current collector 132. The positive electrode substrate tabs 138 may be formed on the positive electrode uncoated portion 136 in a width direction of the positive electrode current collector 132. The positive electrode substrate tab 138 may be formed, for example, by pressing the positive electrode uncoated portion 136 to a certain shape. The positive electrode substrate tab 138 may have a quadrangular shape. The plurality of positive electrode substrate tabs 138 extend outward from the positive electrode current collector 132. In FIG. 2, the plurality of positive electrode substrate tabs 138 extend upward in FIG. 2.

As the electrode assembly 100 is wound, the positive electrode substrate tabs 138 are stacked. The positive electrode substrate tabs 138 form a path for a current flow between the positive electrode plate 130 and the second strip terminal 600. As described above, the stacked positive electrode substrate tabs 138 may be spaced apart from each other so as not to overlap the plurality of stacked negative electrode substrate tabs 118 in the wound assembly.

The number of the plurality of negative electrode substrate tabs 118 may be the same as the number of the plurality of positive electrode substrate tabs 138. However, present disclosure is not limited to such a configuration, and the number of the plurality of negative electrode substrate tabs 118 may be different from the number of the plurality of positive electrode substrate tabs 138. Among the negative electrode plate 110 and the positive electrode plate 130, an electrode plate having a thicker substrate may include more substrate tabs.

The negative electrode substrate tabs 118 may be collected, and the first strip terminal 500 may be welded onto the collected negative electrode substrate tabs 118. The welding may be laser welding or ultrasonic welding. The first strip terminal 500 serves to electrically connect an external device of the secondary battery 10 to the negative electrode substrate tabs 118. The first strip terminal 500 may be in the form of a thin film or film and may include a first insulating portion 510 for insulation from the pouch 300. As shown in FIG. 1, the first insulating portion 510 may be formed in an area that contacts the pouch 300.

A width of the first strip terminal 500 may correspond to a width of the negative electrode substrate tab 118. In this configuration, an area in which welding is performed may be an area in which the first strip terminal 500 is in contact with the negative electrode substrate tab 118. A shape of a welding spot may be a plurality of points, a plurality of straight lines or curves, or a specific figure, and the shape may vary according to a setting of a laser welding device.

When the welding of the first strip terminal 500 is completed, the negative electrode substrate tab 118 and the first strip terminal 500 are bent.

Similarly, the second strip terminal 600 including a second insulating portion 610 may be welded onto the plurality of positive electrode substrate tabs 138 collected from a lower end portion of the electrode assembly 100. When the welding of the second strip terminal 600 is completed, the positive electrode substrate tab 138 and the second strip terminal 600 are bent. Thereafter, the electrode assembly 100 may be accommodated in the pouch 300.

The electrode assembly 100 having such a structure is accommodated in the pouch 300 together with an electrolyte. As shown in FIG. 1, the pouch 300 may have an accommodation space capable of accommodating the electrode assembly 100. The pouch 300 may be referred to as a laminate outer material, a case, a pouch outer material, a pouch case, or the like.

The pouch 300 may include a first pouch layer 301 and a second pouch layer 302, with end portions of the first and second pouch layers 301 and 302 being connected to each other. The electrode assembly 100 may be disposed between the first pouch layer 301 and the second pouch layer 302. As shown in the embodiment depicted in FIG. 1, the plurality of negative electrode substrate tabs 118 and the plurality of positive electrode substrate tabs 138 may extend toward a side opposite to a side at which the first pouch layer 301 and the second pouch layer 302 are connected to each other.

The pouch 300 may have, for example, a quadrangular shape. The first pouch layer 301 and the second pouch layer 302 may be sealed to each other at along the three sides other than the one side at which the first pouch layer 301 and the second pouch layer 302 are connected to each other.

The pouch 300 may include a body 310 in which the electrode assembly 100 is embedded. That is, the electrode assembly 100 may be accommodated in the body 310. The body 310 may refer to a portion where the first pouch layer 301 is not in contact with the second pouch layer 302.

The pouch 300 may include a wing portion 330 disposed at an outer periphery of the body 310. When the electrode assembly 100 is accommodated in the body 310, the wing portion 330 may be sealed by heat fusion or the like. The wing portion 330 may refer to a portion at which the first pouch layer 301 is in contact with the second pouch layer 302.

In more detail, the wing portion 330 may be a side surface of the pouch 300 where the first pouch layer 301 and the second pouch layer 302 are sealed to each other. Further, the wing portion 330 may refer to an edge from which the plurality of negative electrode substrate tabs 118 and the plurality of positive electrode substrate tabs 138 do not extend among edges at which the first pouch layer 301 and the second pouch layer 302 that are sealed to each other.

The wing portion 330 may be folded such that the first pouch layer 301 and the second pouch layer 302 are not separated from each other after sealing. FIG. 1 is a perspective view showing the first pouch layer 301 and the second pouch layer 302 not sealed and, thus, illustrates the wing portion 330 before being folded. As shown in FIG. 3, the wing portion 330 may be folded about an axis that extends in a longitudinal direction of the electrode assembly 100.

However, after folding the wing portion 330, the wing portion 330 may spring back to an unfolded state where the wing portion 330 is positioned before being folded. To prevent the folded wing portion 330 from being unfolded, an adhesive or other additives may be applied to a folded portion of the wing portion 330 or add other components may be added such as tape. However, such additions to the pouch 300 may cause chemical defects in the secondary battery 10 and may increase the thickness or weight of the secondary battery 10.

Hereinafter, a secondary battery 10 that has improved reliability and includes a folded wing portion 330 that is chemically stable, has physical advantages, and prevents foreign materials from entering a pouch 300 will be described.

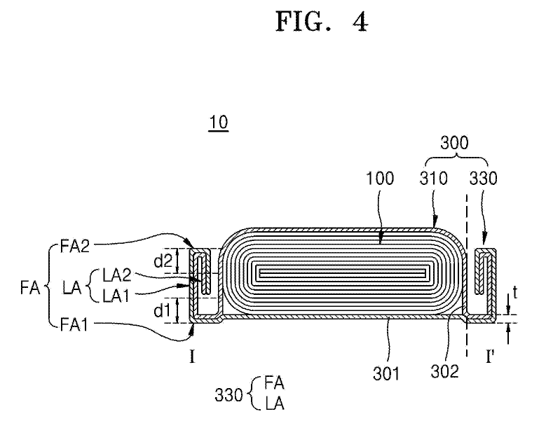

FIG. 4 is a cross-sectional view taken along line I-I’ of FIG. 3.

Referring to FIG. 4, a secondary battery 10 according to the present disclosure may include a pouch 300 and an electrode assembly 100 accommodated inside the pouch 300. The pouch 300 may include a wing portion 330 that extends from a side surface and is folded. To structurally stabilize a folded portion of the wing portion 330 without other chemical materials or physical components, the folded portion of the wing portion 330 may be irradiated with light to reduce elongation. The folded portion of the wing portion 330 may be photo-sintered to increase hardness.

An area where the physical properties are changed by light irradiation in the wing portion 330 may be defined as a folded portion FA, and a portion of the wing portion 330 other than the folded portion FA may be defined as an extension portion LA. The folded portion FA may include a first folded portion FA1 and a second folded portion FA2 (which will be described below). The extension portion LA may include a first extension portion LA1 and a second extension portion LA2 (which will be described below).

The wing portion 330 may include the first folded portion FA1 that is folded about an axis that extends in a longitudinal direction of the electrode assembly 100. The wing portion 330 in the folded state may further include the first extension portion LA1 extending in a thickness direction of the electrode assembly 100. The first folded portion FA1 may connect the first extension portion LA1 to a body 310 of the pouch 300.

The wing portion 330 may further include the second folded portion FA2 that is folded about the axis in the longitudinal direction of the electrode assembly 100 and toward the body 310 from an end portion of the first extension portion LA1 that is opposite to the end portion of the first extension portion LA1 that is connected to the first folded portion FA1.

A length of the folded portion FA may be defined as a distance from an end of the folded portion FA to the extension portion LA in the thickness direction of the electrode assembly 100. To prevent the folded wing portion 330 from springing back to an unfolded state, the length of the folded portion FA may be, for example, 200% or more of a thickness t of the walls of the pouch 300. Specifically, a length d1 of the first folded portion FA1 and a length d2 of the second folded portion FA2 may each be 200% or more of the thickness t of the walls of the pouch 300.

The wing portion 330 may further include the second extension portion LA2 extending from a side opposite to an end portion of the first folded portion FA1 that is connected to the first extension portion LA1. The second extension portion LA2 may extend in the thickness direction of the electrode assembly 100 in a state where the wing portion 330 is folded. The second extension portion LA2 may be located between the first extension portion LA1 and the body 310. To prevent the electrode assembly 100 from being affected when the second folded portion FA2 is irradiated with light, the second folded portion FA2 and the body 310 may be spaced apart from each other.

In other words, the wing portion 330 may include the first folded portion FA1 that extends from a side surface of the body 310 in a width direction of the electrode assembly 100 and then is bent in the thickness direction of the electrode assembly 100, the first extension portion LA1 that continues to extend from the first folded portion FA1 bent in the thickness direction of the electrode assembly 100, the second folded portion FA2 that is bent from the first extension portion LA1 to a space between the first extension portion LA1 and the body 310, and the second extension portion LA2 that extends from the second folded portion FA2 to a space between the first extension portion LA1 and the body 310.

An angle that the folded portion FA is bent to prevent the folded portion from unfolding may be, for example, 90˚ or less. An angle between the first folded portion FA1 and the second folded portion FA2 may be 90˚ or less.

The hardness of one area of the wing portion 330 may be greater than the hardness of one area of the body 310. In particular, the hardness of the folded portion FA may be greater than the hardness of the body 310. Further, the hardness of the first folded portion FA1 and the second folded portion FA2 may be greater than the hardness of the body 310.

The hardness of the folded portion FA may be greater than the hardness of the extension portion LA. Specifically, the hardness of the first folded portion FA1 and the second folded portion FA2 may be greater than the hardness of the first extension portion LA1 and the second extension portion LA2.

The elongation of an area of the wing portion 330 may be less than the elongation of an area of the body 310. The elongation of the folded portion FA may be less than the elongation of the body 310. Specifically, the elongation of the first folded portion FA1 and the second folded portion FA2 may be less than the elongation of the body 310.

The elongation of the folded portion FA may be less than the elongation of the extension portion LA. Specifically, the elongation of the first folded portion FA1 and the second folded portion FA2 may be less than the elongation of the first extension portion LA1 and the second extension portion LA2.

The grain size of an area of the wing portion 330 may be greater than the grain size of an area of the body 310. The grain size of the folded portion FA may be greater than the grain size of the body 310. Specifically, the grain size of the first folded portion FA1 and the second folded portion FA2 may be greater than the grain size of the body 310.

The grain size of the folded portion FA may be greater than the grain size of the extension portion LA. Specifically, the grain sizes of the first folded portion FA1 and the second folded portion FA2 may be greater than the grain size of the first extension portion LA1 and the second extension portion LA2.

The grain size of the folded portion FA may be, for example, 100 μm or more. Specifically, the grain size of the first folded portion FA1 and the second folded portion FA2 may be 100 μm or more. As another example, the grain size of the extension portion LA may be, for example, in a range of 1 nm to 10 μm. Specifically, the grain size of the first extension portion LA1 and the second extension portion LA2 may be in a range of 1 nm to 10 μm.

Because of differences in hardness, elongation, and grain size of the folded portion FA as described above, the bent folded portion FA may stay folded and may not be unfold. That is, a shape of the bent wing portion 330 is stabilized.

A first pouch layer 301 and a second pouch layer 302 are bonded to each other at the wing portion 330. More specifically, a first layer, a second layer, and a third layer of each of the first pouch layer 301 and the second pouch layer 302 may be sequentially stacked, and the first layer of the first pouch layer 301 and the first layer of the second pouch layer 302 may be bonded to each other.

The pouch 300 may include at least one of nylon, aluminum, or polypropylene. More specifically, the first pouch layer 301 and the second pouch layer 302 may each include at least one of nylon, aluminum, or polypropylene, and the polypropylene may be crystalline polypropylene (CPP). As specific examples, the first layers of the first pouch layer 301 and the second pouch layer 302 may include CPP, the second layers thereof may include aluminum, and the third layers thereof may include nylon.

In the folded portion FA, the hardness of the second and third layers of the first pouch layer 301 and the second pouch layer 302 may increase, and the elongation may decrease. The grain size of the second layer and the third layer of the first pouch layer 301 or the second pouch layer 302 in the folded portion FA may be greater than the grain size of the second layer and the third layer of the first pouch layer 301 and the second pouch layer 302 in the body 310. The grain size of the second layer and the third layer of the first pouch layer 301 and the second pouch layer 302 in the folded portion FA may be 100 μm or more.

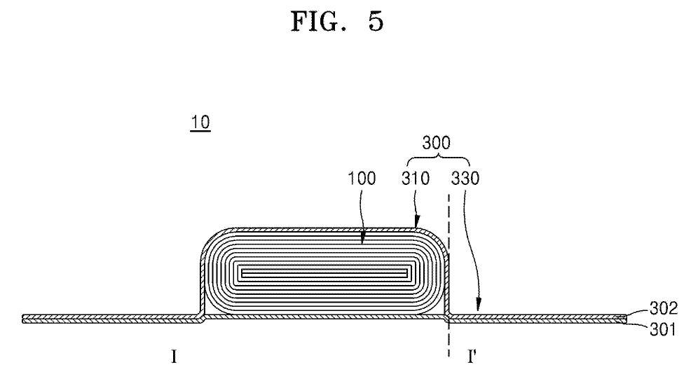

FIGS. 5 to 9 are cross-sectional views illustrating a process of manufacturing a secondary battery 10 according to an embodiment of the present disclosure.

The process of manufacturing the secondary battery 10 may include forming an electrode assembly 100,accommodating the electrode assembly 100 in a pouch 300, sealing a wing portion 330 of the pouch 300, forming a folded portion FA by folding the wing portion 330 in a direction parallel to a longitudinal direction of the electrode assembly 100, and irradiating light onto the folded portion FA to increase the strength of the folded portion FA. As an example, in the increasing of the strength of the folded portion FA, the folded portion FA may be photo-sintered.

The forming of the folded portion FA may include forming a second folded portion FA2 by performing primary folding about an axis in the longitudinal direction of the electrode assembly 100 and forming a first folded portion FA1 by performing secondary folding toward the electrode assembly 100.

In the forming of the second folded portion FA2, light may be irradiated onto a first folded area after the first folding. And in the forming of the first folded portion FA1, light may be irradiated onto a second folded area after the second folding.

Referring to FIG. 5, after the electrode assembly 100 is formed, the electrode assembly 100 may be accommodated in a body 310 between a first pouch layer 301 and a second pouch layer 302. Then, the wing portion 330, which is an area in which the first pouch layer 301 is in contact with the second pouch layer 302, may be sealed. In this case, the wing portion 330 may be sealed in a state in which the wing portion 330 extends from the body 310 in a width direction of the electrode assembly 100. During the sealing process, first layers of the first pouch layer 301 and the second pouch layer 302 are melted and bonded to each other. In specific examples, before sealing a length of the wing portion 330 in the width direction of the electrode assembly 100 may be in a range of 120% to 200% of a thickness of the body 310.

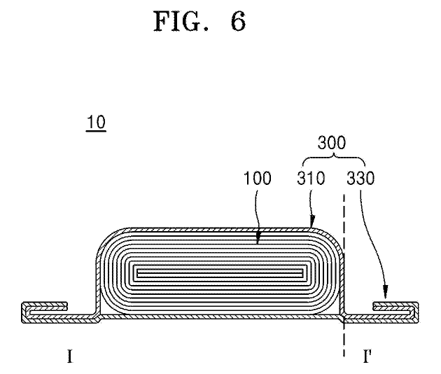

Referring to FIG. 6, after the sealing of the wing portion 330, the wing portion 330 extending in the width direction of the electrode assembly 100 may be first folded about the axis that extends in the longitudinal direction of the electrode assembly 100. The primary folding may be performed at a distance from the body 310 that is 100% or more of the thickness of the body 310. In other words, a folding axis during the primary folding may be located from the body 310 at a distance of 100% or more of the thickness of the body 310 in the width direction of the electrode assembly 100.

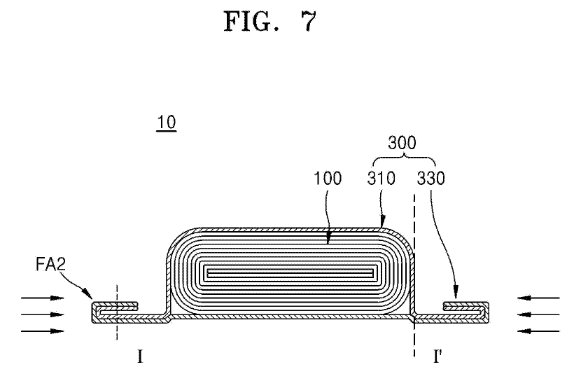

Referring to FIG. 7, after the primary folding, light may be irradiated onto the first folded area of the wing portion 330 to form the second folded portion FA2 to change its physical properties. The second folded portion FA2 formed through light irradiation may have increased strength and hardness, decreased elongation, and an increased grain size as compared to before light irradiation. Thus, a bent shape of the second folding portion FA2 is structurally stabilized, and the secondary battery 10 becomes physically and chemically stable, thereby improving reliability.

When light is irradiated onto the first folded area, the first folded area may be sintered to have increased strength, thereby forming the second folded portion FA2. The hardness of the second folded portion FA2 may be greater than the hardness of the body 310 and the hardness of a first extension portion LA1.

In specific examples, during light irradiation, intense pulsed light (IPL) may be applied, and the IPL may have a wavelength of 300 nm to 1200 nm, an energy of about 10 J, and may be applied for 60 seconds to 300 seconds.

As the IPL is irradiated, particles in the second and third layers of the first pouch layer 301 and the second pouch layer 302 may be sintered so that a grain boundary may be reduced, and the particles may coarsen. That is, a grain size may increase and, thus, elongation at which deformation may occur due to external pressure may decrease. A length d2 of the formed second folded portion FA2 may be 200% or more of a thickness t of the pouch 300.

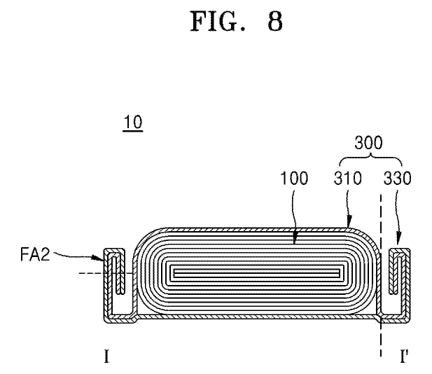

Referring to FIG. 8, after the second folded portion FA2 is formed, the wing portion 330 between the second folded portion FA2 and the body 310 may be folded a second time. In the second folding, the wing portion may be bent toward the electrode assembly 100 about the axis that extends in the longitudinal direction of the electrode assembly 100. An axis of the second folding may be located, for example, from the body 310 at a distance of 10 % or more of the thickness of the body 310.

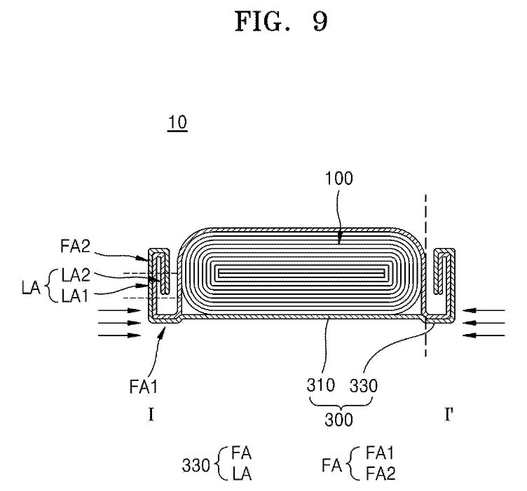

Referring to FIG. 9, after the second folding, light may be irradiated onto the second folded area of the wing portion 330 to form the first folded portion FA1 of which the physical properties are changed. The first extension portion LA1 may be disposed between the second folded portion FA2 and the first folded portion FA1. The wing portion 330 may further include a second extension portion LA2 extending from a side opposite to an end portion the first folded portion FA1 that is connected to the first extension portion LA1. And the second extension portion LA2 may be located between the first extension portion LA1 and the body 310.

The first folded portion FA1 formed with light irradiation may have increased strength and hardness, decreased elongation, and an increased grain size as compared to before light irradiation. Thus, a bent shape of the first folded portion FA1 is structurally stabilized, and the secondary battery 10 becomes physically and chemically stable, thereby improving reliability.

When light is irradiated onto the second folded area, the second folded area may be sintered to increase the strength of the second folded area, thereby forming the first folded ported FA1. The hardness of the first folded portion FA1 may be greater than the hardness of the body 310 and the hardness of the first extension portion LA1.

In specific examples, during light irradiation, IPL may be applied, and as an example, the IPL may have a wavelength of 300 nm to 1200 nm, an energy of about 10 J, and may be applied for 60 seconds to 300 seconds. As the IPL is irradiated, particles of second and third layers of the first pouch layer 301 and the second pouch layer 302 may be sintered so that grain boundaries may be reduced, and the particles may coarsen. That is, a grain size may increase and, thus, elongation at which deformation may occur due to external pressure may decrease. A length d1 of the formed first folded portion FA1 may be 200 % or more of the thickness t of the walls of the pouch 300.

According to embodiments of the present disclosure, there may be provided a secondary battery having improved stability by including a pouch having a folded wing portion that does not include other additives.

However, the effects that may be achieved through the present disclosure are not limited to the above-described effects, and other technical effects that are not described herein will be clearly understood by those skilled in the art from the present disclosure.

Although the present disclosure has been described with embodiments and drawings, the present disclosure is not limited to thereto. Rather, it will be appreciated by those skilled in the art that various modifications and changes may be made to the embodiments without departing from the principles and spirit of the present disclosure.

What is claimed is:

1. A secondary battery comprising:
an electrode assembly; and
a pouch comprising a body in which the electrode assembly is accommodated, the pouch including a wing portion extending from a side of the body,
wherein the wing portion comprises an extension portion extending in a thickness direction of the electrode assembly and a folded portion folded about an axis that extends in a longitudinal direction of the electrode assembly, with the folded portion connecting the extension portion to the body, and
wherein a hardness of an area of the wing portion is greater than hardness of an area of the body.

2. The secondary battery of claim 1, wherein an elongation of the area of the wing portion is less than an elongation of the area of the body.

3. The secondary battery of claim 1, wherein a grain size of the area of the wing portion is greater than a grain size of the area of the body.

4. The secondary battery of claim 1, wherein a length of the first folded portion is 200% or more of a thickness of a wall of the body of the pouch.

5. The secondary battery of claim 1, wherein the folded portion is a first folded portion, and
wherein the secondary battery further comprises a second folded portion folded about the axis toward the body and extending from a side portion of the extension portion that is not connected to the first folded portion.

6. The secondary battery of claim 5, wherein a hardness of the second folded portion is greater than a hardness of the extension portion.

7. The secondary battery of claim 5, wherein an elongation of the second folded portion is less than an elongation of the extension portion.

8. The secondary battery of claim 5, wherein a grain size of the second folded portion is greater than a grain size of the extension portion.

9. The secondary battery of claim 5, wherein a grain size of the second folded portion is 100 μm or more.

10. The secondary battery of claim 5, wherein the extension portion is a first extension portion,
wherein the secondary battery further comprises a second extension portion extending from a side of the second folding portion that is connected to the first extension portion, and
wherein the second extension portion is located between the first extension portion and the body.

11. The secondary battery of claim 5, wherein the second folded portion is spaced from the body.

12. A method of manufacturing a secondary battery, the method comprising:
forming an electrode assembly;
accommodating the electrode assembly in a body of a pouch, with the pouch including a wing portion extending from a side of the body;
sealing the wing portion of the pouch;
forming a folded portion by folding the wing portion about an axis that extends in a longitudinal direction of the electrode assembly; and
irradiating light onto the folded portion to increase strength of the folded portion,
wherein a hardness of an area of the wing portion is greater than a hardness of an area of the body.

13. The method of claim 12, wherein an elongation of the area of the wing portion is less than an elongation of the area of the body.

14. The method of claim 12, wherein a grain size of the area of the wing portion is greater than a grain size of the area of the body.

15. The method of claim 12, wherein the increasing of the strength of the folded portion comprises photo-sintering the folded portion.

16. The method of claim 12, wherein a length of the folding portion is 200 % or more of a thickness of a wall of the body of the pouch.

17. The method of claim 12, wherein the forming of the folded portion comprises forming a second folded portion by performing a first folding about the axis, and forming a first folded portion by performing second folding toward the electrode assembly, and
wherein an extension portion is disposed between the first folded portion and the second folded portion.

18. The method of claim 17, wherein the forming of the second folded portion comprises irradiating light onto a first folded area after the first folding, and
wherein the forming of the first folded portion comprises irradiating light onto a second folded area after the second folding.

19. The method of claim 17, wherein a hardness of the second folded portion is greater than a hardness of the extension portion.

20. The method of claim 17, wherein the extension portion is a first extension portion,
wherein the secondary battery further comprises a second extension portion extending from a side opposite to a side of the second folded portion that is connected to the first extension portion, and
wherein the second extension portion is located between the first extension portion and the body.
